(19) United States
(12) Patent Application Publication
(10) Pub. No.: US 2013/0337102 A1
(43) Pub. Date: Dec. 19, 2013

(54) Embossing Press

(71) Applicant: Massachusetts Institute of Technology, Cambridge, MA (US)

(72) Inventors: David E. Hardt, Concord, MA (US); Maia Reynolds Bageant, Cambridge, MA (US); Joseph Edward Petrzelka, Cambridge, MA (US)

(73) Assignee: Massachusetts Institute of Technology, Cambridge, MA (US)

(21) Appl. No.: 13/916,057

(22) Filed: Jun. 12, 2013

Related U.S. Application Data
(60) Provisional application No. 61/659,665, filed on Jun. 14, 2012.

(51) Int. Cl. B29C 59/02

(52) U.S. Cl. CPC B29C 59/02
USPC 425/385

(57) ABSTRACT

Precision embossing press. The press includes a rigid symmetric box frame and upper and lower parallel embossing platens mounted within the box frame for movement towards one another to provide an embossing compressive force on a work piece between the platens while maintaining parallelism between the platens. A thermal system controls platen temperature to heat the work piece for embossing and to cool the work piece for de-molding. A pneumatic actuator moves the lower platen toward the upper platen to emboss the work piece. A closed loop control system employing feedback and feed forward control loops controls platen temperatures and embossing force.

This application claims priority to provisional application Ser. No. 61/659,665 filed on Jun. 14, 2012, the contents of which are incorporated herein by reference in their entirety.

### BACKGROUND OF THE INVENTION

This invention relates to an embossing press and more particularly to a precision embossing press that can be constructed from common an inexpensive mechanical elements, but that provides high resolution motion, loading and sensing with high bandwidth thermal actuation.

Polymer embossing can be used to form surface geometry in polymer work pieces. However, producing microscale parts by hot embossing is a method currently not commonly employed on an industrial scale. Achieving quality formation of microscale features at a sufficient rate has been a major difficulty. In microfluidic applications, however, embossing has been a viable manufacturing process for moderate product volumes in comparison to injection molding.

A hot embossing process utilizes three primary steps: the work piece is heating, compressed between two optionally patterned platens to form a desired surface geometry and cooled and de-molded from the platen. The embossing process is sensitive to temperature and load parameters, requiring careful control of temperature and pressure.

In many embossing applications, including microfluidic device manufacture, the registration of surface geometry to the work piece is a critical manufacturing feature. Thus, an embossing press must provide means for locating work pieces and provide for repeatable motion.

### SUMMARY OF THE INVENTION

The precision embossing press of the invention includes a rigid symmetric box frame and upper and lower parallel embossing platens mounted within the box frame for movement towards one another to provide an embossing compressive force on a work piece between the platens while maintaining parallelism between the platens. A thermal system controls platen temperature to heat the work piece for embossing and to cool the work piece for de-molding. An air bushing supports the lower platen for motion toward the upper platen and includes a flexural bearing to fix rotary position of the lower platen. A pneumatic actuator moves the lower platen toward the upper platen to emboss the work piece and a flexural bearing is provided having three degrees of freedom for adjusting position of the upper platen. A load cell measures embossing force and a closed loop centered system employing feedback and feed forward control loops controls platen temperature and embossing force.

In a preferred embodiment the box frame deflects less hem 5 micrometers per 1,000 newtons of loading force. In this embodiment, the box frame is constructed of aluminum plate and includes individual elements connected by kinematic structures and removable fasteners. In a preferred embodiment, the thermal system heats the platens with resistive heaters and cools the platens with liquid cooling. It is preferred that platen temperature be monitored by a thermocouple.

In yet another embodiment, each platen includes an insulating block, a conductive cooling block, a conductive heating block and an embossing tool bearing a desired embossing pattern. The insulating block may be made of fiberglass reinforced ceramic and the conductive blocks may be made of aluminum. The embossing tool may be made of an amorphous metal. It is preferred that the pneumatic actuator be a rubber bladder or bellows.

The embossing press design disclosed herein offers several advantages over existing methods. The embossing press of the invention is designed to maintain micron-level precision during the embossing process that is simple in design and significantly lower in cost than competing systems. The press according to the invention is highly compact and presents a much smaller form factor than competing devices while still offering more than sufficient force and temperature capabilities necessary to emboss, for example, a 25 mm by 25 mm polymer substrate. The invention is also capable of micron-level repeatability. Utilizing passive kinematic alignment features and precise, completely linear motion, the embossing press of the invention achieves precision and repeatability of forming on the micron level using relatively simple structures. The system is capable of rapid heating and cooling cycles due to low thermal mass of its forming platens. The rapid heating and cooling enables low cycle times for producing single parts.

An important aspect of the present design is that it can be scaled for different sized products. For example, the design can be scaled up to emboss a 55 mm by 85 mm polymer substrate (credit card size) or larger using the design disclosed herein but with suitably adjusted dimensions to allow for economical “right sizing” of the embossing press.

### BRIEF DESCRIPTION OF THE DRAWING

FIG. 1 is a cross-sectional view of the embossing press according to an embodiment of the invention.

FIG. 2 is an exploded view of a platen stack according to an embodiment of the invention.

FIG. 3 is a perspective view of a planar flex oral bearing providing three degrees of freedom according to an embodiment of the invention.

FIG. 4 is a block diagram of a representative controller architecture to control embossing force and temperature.

### DESCRIPTION OF THE PREFERRED EMBODIMENT

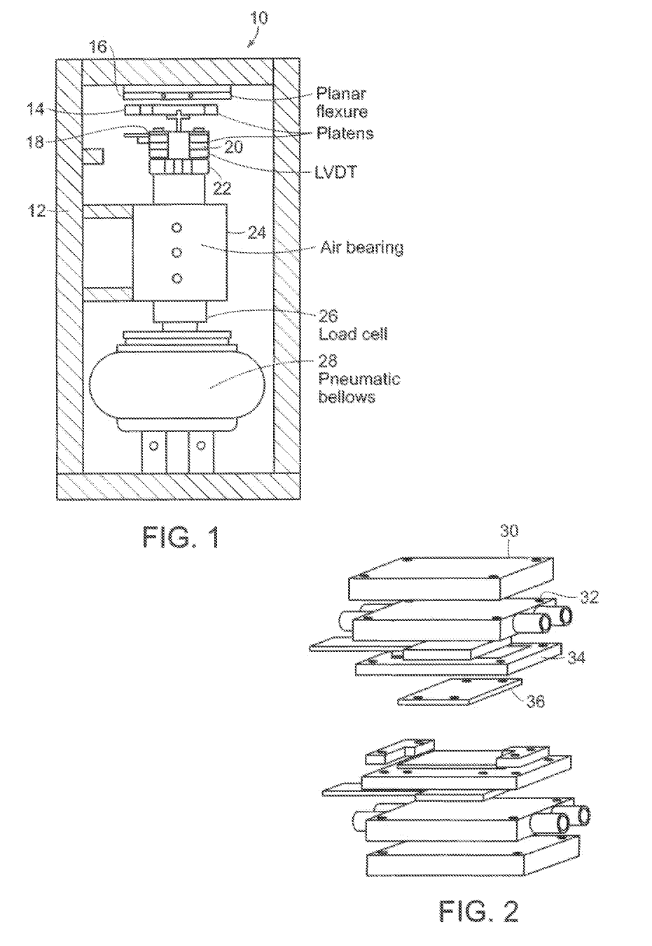

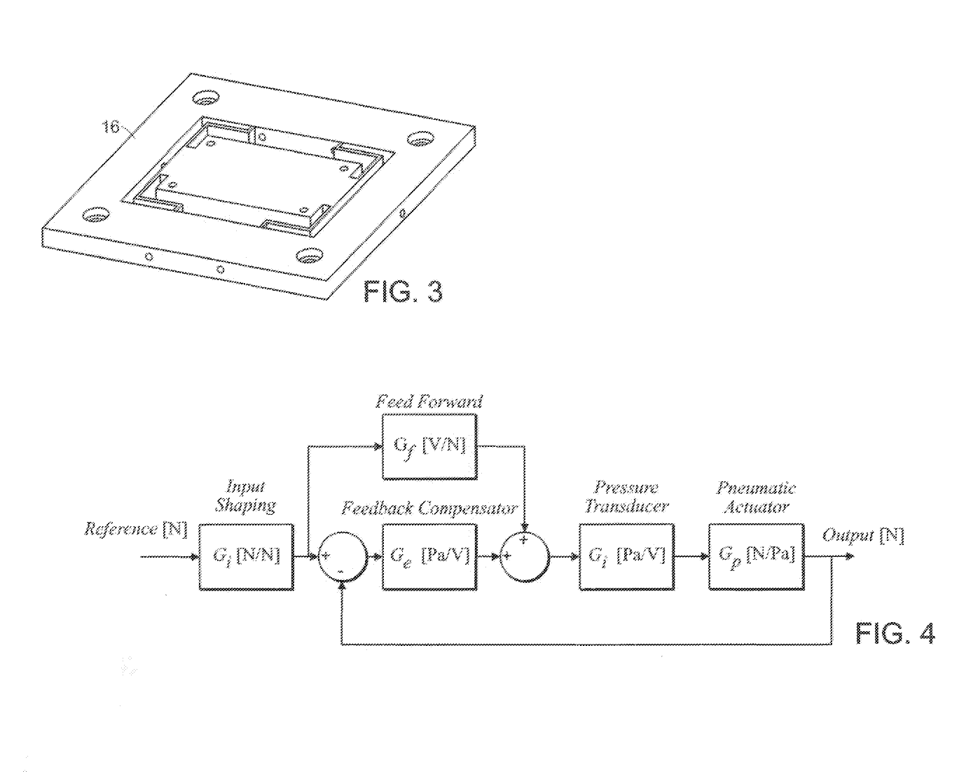

With reference first to FIG. 1 an embossing press 10 includes a box frame structure 12. The box frame 12 provides superior deflection and thermal performance while being smaller and lighter than other comparable designs.

During embossing, a load most be applied to material compressed between two platens while maintaining parallelism between the platens. In a preferred embodiment, the box frame 12 is designed to deflect less than 5 microns per 1,000 newtons of loading force. Because of the symmetry of the box frame 12, any deformation has no parasitic angular component that will affect platen alignment.

The embossing press 10 must also sustain large changes in temperature during embossing and de-molding cycles. The symmetry of the box frame 12 ensures that any deformation due to thermal gradients is manifest as a linear translation between the platens and not a change in parallelism. In a preferred embodiment, the box frame 12 is constructed of aluminum plates and may be comprised of individual elements that are connected by a series of kinematic elements and removable fasteners, thereby allowing precise reassembly of the frame 12 after servicing.

With reference still to FIG. 1, an upper platen 14 engages a planar flexural bearing 16. A lower platen 18 is mounted on a shaft 20 and includes an LVDT 22 for measuring platen displacements. The shaft 20 is supported in an air bearing 24. A load cell 26 measures the load force and pneumatic bellows 28 provides a force urging the upper and lower platens together to emboss a work piece therebetween. Because temperature control of the embossing process is important the thermal system disclosed herein is an important component. The thermal system includes the platens and components adjacent to the embossing work piece that are designed to beat the work piece for embossing and to cool the work piece for de-molding. Precision embossing requires that the temperature of each platen be carefully controlled while short and economical processing cycles require a fast thermal response time.

In a preferred embodiment of the invention, thermal actuation at each platen is provided by resistive heaters and liquid cooling, with separate control circuits and valves (not shown) for each component. The temperature at each platen is monitored by, for example, a thermocouple. With reference now to FIG. 2, each platen is comprised of an insulating block 30, a conductive cooling block 32, a conductive heating block 34 and an embossing tool 36 with a desired embossing pattern. In a preferred embodiment, insulating materials in the insulating block 30 comprises fiberglass reinforced ceramic. The conductive blocks 32 and 34 may be aluminum and the embossing tool 36 may be made from an amorphous metal. In a representative embodiment, the insulating layer and heating blocks are each about 6 mm in thickness. In an alternative embodiment, the heating and cooling blocks 34 and 32 can be combined as one element. In yet another embodiment, the cooling and healing blocks could be interchanged or combined without changing the utility of the design.

The insulating block 30 isolates the heating block 34, cooling block 32 and embossing tool 36 from the substantial thermal mass of the press disclosed herein. This isolation permits faster heating and cooling times with smaller heaters and cooling equipment.

It should be noted that a valve may be provided to purge the liquid cooling circuit with air during die heating cycle. The equivalent thermal mass of the press is much smaller when liquid is purged from the cooling block 32, providing a faster heater response time with smaller heating elements. In a preferred embodiment, the embossing press 10 is able to heat from about 60° C. to about 150° C. in 60 seconds, and cool from 150° C. to about 60° C. in 20 seconds. With these heating and cooling times, one work piece can be processed in about 3 minutes.

In a preferred embodiment, the upper and lower platen thermal systems are constructed identically for symmetric heating and cooling of the work piece during embossing and de-molding.

Returning to FIG. 1, die top platen 14 is fixed to the top of die box frame 12. The lower platen 18 translates vertically beneath the upper platen 14. The hearing 24, actuator 28 and sensor system for this translation has been designed to utilize frictionless machine elements. Frictionless design permits nominally infinite motion resolution, good heatability, and observation of very small embossing or de-molding forces.

The lower platen 18 is fixed to the rigid circular shaft 20 that is guided by the air hushing 24, The bushing 24 is rigidly fixed to the box frame structure 12. The use of the air bushing 24 provides precise motion, high stiffness in the constrained directions, and a compact form (relative to rolling element bearings or flexural bearings). To fix the rotary position of the shaft 20 a flexural bearing is used to constrain the shaft relative to the box frame. In a preferred embodiment, the flexural bearing is a single flexure blade element. Alternative, the rotary position of the shaft 20 may be constrained by a second parallel guide shaft that travels in a second parallel air bushing (not shown).

In a preferred embodiment, embossing force is provided by the pneumatic actuator 28 mounted between the circular shaft 20 and the box frame 12. The pneumatic actuator may be a rubber bladder or bellows. For example, a rubber bladder about 100 mm in diameter can provide large forces at moderate pneumatic pressure but eliminates stick-slip friction associated with pneumatic cylinders. In an alternate embodiment, a pneumatic cylinder (not shown) may be used in place of the rubber bladder 28. In yet another embodiment, pressurize fluid can be used to drive the actuator. Measurements conducted on a prototype embossing press according to the invention show that the rubber bladder 28 provides exceptionally linear pneumatic pressure-applied force behavior (R²=0.999).

As mentioned earlier, the upper and lower platens need to remain parallel during the embossing process. Thus alignment is an important issue. To register the upper platen 14, a flexural bearing 16 (FIG. 13) provides three degrees of freedom, two orthogonal translations and one rotation for adjustment. Screw stops allow fine adjustment of the platen position. The flexural bearing 16 remains rigid in compression against the top of the box frame structure 12 during embossing. It is preferred that each platen 14 and 18 be fit with a thermocouple for high bandwidth, high resolution measurement of temperature.

A linear variable differential transformer (LVDT) 22 is mounted between the two platens 14 and 18. This analog sensor provides sub-micron resolution and can be installed in a contact-free configuration to eliminate friction. In an alternative embodiment, a linear encoder (not shown) may be used as a non-contact measurement technique to measure the displacement between the upper and lower platens.

Force is measured using the load cell 26 mounted between the actuator 28 and guide shaft 20. The load cell 26 is positioned far from the thermal actuators to minimize thermal drift and maintain sensor accuracy. These sensors permit accurate, high resolution measurement of processing conditions. The combination of load and displacement sensors allows monitoring the mechanical embossing and de-molding energies for the purposes of process studies (i.e., experimentation), process monitoring, and process feedback control.

With reference now to FIG. 4, in a preferred embodiment the temperature of each platen 14 and 18 is controlled using feedback and feed forward control loops. These loops ensure reference tracking and precise processing temperatures within the accuracy and resolution of the temperature sensors. In this embodiment, the embossing force is also controlled using feedback and feed forward control loops to ensure good reference tracking and precise processing forces within the accuracy and resolution of the load cell 26.

It is recognized that modifications and variation of the present invention will occur to those of ordinary skill in the art and it is intended that all such modifications and variations be included within the scope of the appended claims such modifications and variations be included within the scope of the appended claims.

1. Precision embossing press comprising:
a rigid, symmetric box frame;
upper and lower parallel embossing platens mounted within the box frame for movement towards one another to provide an embossing compressive force on a work piece between the platens while maintaining parallelism between the platens;
a thermal system to control platen temperature to heat the work piece for embossing and to cool the work piece for de-molding;
an air bushing supporting the lower platen for motion toward the upper platen and including a flexural bearing to fix rotary position of the lower platen;
a pneumatic actuator for moving the lower platen toward the upper platen to emboss the work piece;
a flexural bearing providing three degrees of freedom for adjusting position of the upper platen;
a load cell for measuring embossing force; and
a closed loop control system employing feedback and feed forward control loops to control platen temperature and embossing force.

2. The press of claim 1 wherein the box frame deflects less than 5 microns per 1,000 N of loading force.

3. The press of claim 1 wherein the box frame is constructed of aluminum plate and comprises individual elements connected by kinematic elements.

4. The press of claim 1 wherein the thermal system heats the platens with resistive heaters and cools the platens with liquid cooling.

5. The press of claim 4 wherein platen temperature is monitored by a thermocouple.

6. The press of claim 1 wherein each platen includes an insulating block, a conductive cooling block, a conductive heating block and an embossing tool bearing a desired embossing pattern.

7. The press of claim 6 wherein the insulating block is made of fiberglass reinforced ceramic.

8. The press of claim 6 wherein the conductive blocks are made of aluminum.

9. The press of claim 6 wherein the embossing tool is made of an amorphous metal.

10. The press of claim 1 wherein the thermal system heats the platens from 60° C. to 150° C. in approximately 60 seconds, and cools the platens from 150° C. to about 60° C. in 20 seconds.

11. The press of claim 1 wherein the flexural bearing is a single block element.

12. The press of claim 1 wherein the pneumatic actuator is a rubber bladder or bellows.

13. The press of claim 1 wherein the pneumatic actuator is a pneumatic cylinder.

14. The press of claim 1 further including a linear variable differential transformer (LVDT) mounted between the two platens to measure displacement between upper and lower platens.
